(19) United States
(12) Patent Application Publication
(10) Pub. No.: US 2025/0173830 A1
(43) Pub. Date: May 29, 2025

(54) METHODS, SYSTEMS AND DEVICES FOR INCREASING IMAGE RESOLUTION AND DYNAMIC RANGE

(71) Applicant: Arizona Board of Regents on Behalf of the University of Arizona, Tucson, AZ (US)

(72) Inventors: Stanley Pau, Tucson, AZ (US); Amit Ashok, Tucson, AZ (US)

(21) Appl. No.: 18/834,419

(22) PCT Filed: Feb. 3, 2023
(86) PCT No.: PCT/US2023/061924

§ 371 Date: Jul. 30, 2024

Related U.S. Application Data
(60) Provisional application No. 63/306,821, filed on Feb. 4, 2022.

(51) Int. Cl. G06T 5/50; G06T 5/92

(52) U.S. Cl. CPC G06T 5/50; G06T 5/92

(57) ABSTRACT

Methods, devices and systems are described that enable generation of images with enhanced resolution and/or enhance dynamic range. The described systems eliminate the need to laterally shift the system components, or in some systems, any shift all, and instead utilize multiple exposures made at different magnifications, zoom settings, and/or aperture settings to produce images with higher resolution and/or dynamic range. One example method includes acquiring a plurality of images where each image is acquired at a particular magnification factor different than other acquired images. Each of the acquired images is processed to obtain one or more parameters, functions or modified images, and then the images are combined based on the one or more parameters, functions or modified images to obtain an enhanced-resolution image having a resolution that is higher than a resolution of each of acquired images.

### CROSS-REFERENCE TO RELATED APPLICATION(S)

This application claims priority to the provisional application with Ser. No. 63/306,821 titled “METHODS, SYSTEMS AND DEVICES FOR INCREASING IMAGE RESOLUTION AND DYNAMIC RANGE,” filed Feb. 4, 2022. The entire contents of the above noted provisional application are incorporated by reference as part of the disclosure of this document.

### TECHNICAL FIELD

The technology in this patent document generally relates to imaging techniques, and more particularly to methods and devices to increase the resolution of images acquired by an imaging system.

### BACKGROUND

In many diffraction-limited imaging systems, the resolution of the system is often limited by the number and size of the pixels in the imaging sensor. It is naturally advantageous to obtain images with higher resolution than those that can be produced by a single-image capture in such devices. For example, for detector with a fixed pixel number and size, the resolution can be increased by multiple exposures by laterally shifting the lens or an imaging detector to acquire multiple exposures that are subsequently combined to obtain a higher-resolution image. However, in some systems, lateral shifts of the system components may not be possible or may increase the cost of the system. Therefore, there is a need for alternate techniques to produce images with enhanced resolution.

### SUMMARY

Methods, devices and systems are described that enable generation of images with enhanced resolution and/or enhance dynamic range. The disclosed embodiments eliminate the need to laterally shift the system components and instead utilize multiple exposures made at different magnifications, zoom settings, and/or aperture settings to produce images with enhanced resolution and/or dynamic range. The disclosed technology can be implemented with a lower form factor and a lower power consumption.

One example imaging system includes an optical zoom system comprising at least one lens, an imaging detector that includes a plurality of sensor elements and configured to receive light from the optical zoom system, and a processor coupled to a memory comprising instructions The processor is also coupled to the imaging detector and is configured to receive electrical signals from the imaging detector corresponding to images formed on the detector. The optical zoom system of the imaging system is operable to allow a plurality of images to be formed on the imaging detector, where each of the plurality of images is associated with a particular magnification factor that is different from magnification factors associated with other images in the plurality of images. The processor can be configured to receive data representing the plurality of images, to process the received data to produce one or more parameters, functions or modified images, and to combine the plurality of images based on the one or more parameters, functions or modified images to obtain an enhanced-resolution image having a resolution that is higher than a resolution of each of the plurality of images.

### BRIEF DESCRIPTION OF THE DRAWINGS

FIG. 1A illustrates an example imaging system in which image resolution can be improved by moving a focal point array of the imaging system.

FIG. 1B illustrates an example imaging system in which image resolution can be improved by moving a lens of the imaging system.

FIG. 2 illustrates an imaging system with improved image resolution in accordance with an example embodiment.

FIG. 3A illustrates an example focal plane array (FPA) detector with a 3-by-3 array pixels.

FIG. 3B illustrates a 6-by-6 array of pixels that can be produced using the multiple exposures in accordance with an example embodiment.

FIG. 3C shows four images of a 3-by-3 array of pixels, each taken at a different magnification value to illustrate an operation to increase image resolution in accordance with an example embodiment.

FIG. 4A illustrates a method for producing a high-resolution image using multiple exposures in accordance with an example embodiment.

FIG. 4B illustrates another method for producing a high-resolution image using multiple exposures in accordance with an example embodiment.

FIG. 5 illustrates a set of operations to produce a high dynamic range image in accordance with an example embodiment.

FIG. 6 illustrates a set of operations to produce a high-resolution and high dynamic range image in accordance with an example embodiment.

FIG. 7 illustrates a set of operations for obtaining an enhanced image with an imaging system in accordance with an example embodiment.

### DETAILED DESCRIPTION

In many diffraction-limited imaging systems, the resolution of the system is often limited by the number and size of the pixels in the imaging sensor. The sensor or detector can be, for example, a charged coupled device (CCD) or a complementary metal oxide semiconductor (CMOS) sensor for imaging in the visible spectrum. Alternatively, the sensor can be, for example, an indium gallium arsenide (InGaAs) sensor for short wave infrared (SWIR) spectrum, an indium antimonide (InSb) sensor for mid wave infrared (MWIR) spectrum or a micro bolometer array for long wave infrared (LWIR) spectrum. For a fixed pixel number and size, the resolution can be increased by multiple exposures. A common technique is to acquire four exposures by shifting the image.

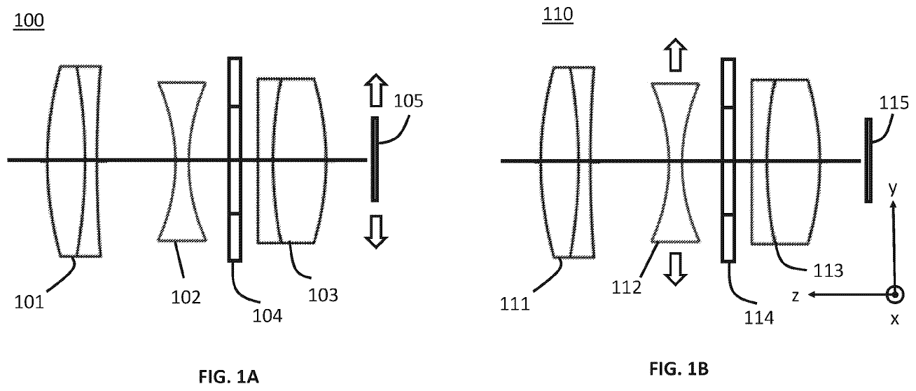

FIG. 1A shows an imaging system 100, comprising a lens assembly with three lenses 101, 102 and 103, an aperture 104 and a focal plane array (FPA) 105 detector (hereinafter referred to as FPA). An input image can be moved relative to the FPA by shifting the FPA 105. For example, an exposure is made at one FPA position. The FPA is shifted by half a pixel in the positive x direction. A second exposure is made. The FPA is shifted by half a pixel in the positive y direction. A third exposure is made. The FPA is shifted by half a pixel in the negative x direction. A fourth exposure is made. The FPA is subsequently shifted by half a pixel in the negative y direction to the original position. Instead of moving the FPA, the image can also be moved by shifting an element in the lens assembly. FIG. 1B shows an imaging system 110, comprising a lens assembly with three lenses 111, 112, 113, an aperture 114 and a FPA 115. The lens element 112 can be shifted in either x or y direction, leading to an image shift relative to the FPA 115. Four exposures can be acquired by shifting the lens similar to the procedures explained in connection with FIG. 1A. The four images can be combined to create an image with twice the resolution. This technique can be generalized by acquiring a different number of images (more than or less than four) at different shifted positions. The shifting can be achieved by moving the lens, moving the FPA or both at different times. In practical application, the entire imaging system is positioned on a tripod or a camera stabilizer.

Another common multiple exposure technique is to acquire multiple images rapidly as the imaging system is moving, either in a predefined controlled manner or in a random configuration. The image acquisition is performed using a fixed focal length lens. The different frame-to-frame low resolution input images are utilized to construct a high-resolution output image. The method can be improved by using deep learning such as convolutional neural network (CNN).

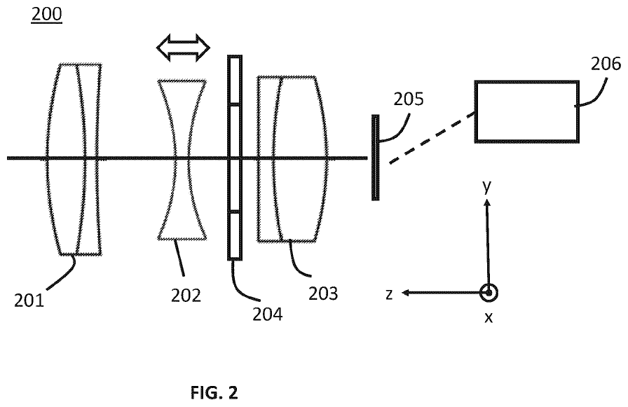

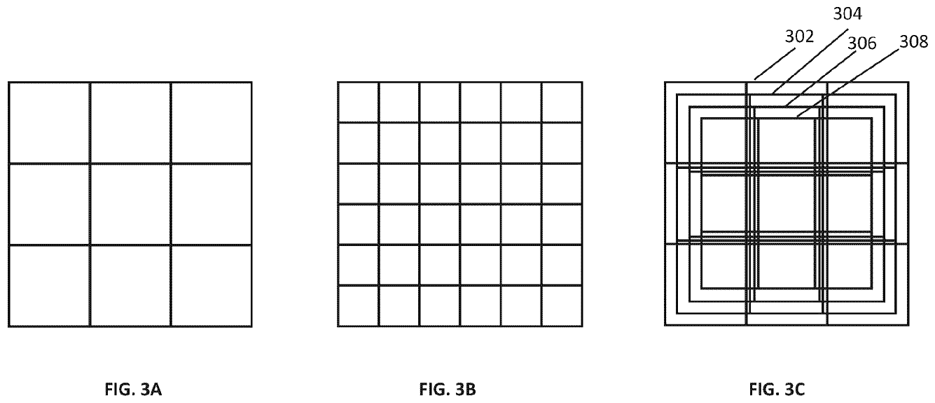

The disclosed embodiments eliminate the need to laterally shift the FPA and/or the lens components and instead utilize multiple exposures made at different magnifications or zoom settings. The disclosed embodiments can thus be applied to systems that do not have the ability to laterally move the FPA and/or lens components, and in some embodiments to systems without requiring shifting of the positions of FPAs or lenses. The disclosed technology generally can be implemented with a lower form factor and a lower power consumption. In one embodiment, four exposures are made at four different magnifications of the image. FIG. 2 shows an imaging system 200 that includes of a zoom lens assembly comprising three lenses 201, 202, 203, an aperture 204 and a FPA 205. The FPA may include, or be communicatively coupled to, a processor 206 which has the capability to receive and process the data representative of FPA-detected signals. The lens element 202 is moved in the z direction to create different magnified images on the FPA. The method is illustrated by considering the following simplified configurations in FIGS. 3A-3B. FIG. 3A shows an FPA with a 3-by-3 array of 9 pixels. The goal is to generate a higher resolution image of a 6-by-6 array of 36 pixels by using multiple exposures as shown in FIG. 3B. This is accomplished by combining four images of the 3-by-3 array of 9 pixels taken at different magnifications. Each magnification step produces an image that can occupy the full extent or a smaller portion of the pixel array. In effect, an image that is taken at a different magnification is equivalent to an image taken using a different pixel size. FIG. 3C shows four images of a 3-by-3 array of 9 pixels 302, 304, 306, 308, each taken at a different magnification value, which is equivalent to obtaining four images with different pixel sizes. The 36 intensity values from the 4 images with differing magnifications (FIG. 3C) are related linearly to the 36 intensity values of the high-resolution image (FIG. 3B).

In some embodiments, the different zoom settings can be achieved by moving one or more of the lenses in the z direction. In some embodiments, the different zoom settings can be achieved by changing the zoom electronically or mechanically without shifting the position of the lenses. For instance, an optical power of one or more liquid lenses can be changed. Liquid lenses contain optical-grade liquids, typically formed as small cells, that can change shape when a current or voltage is applied to the liquid lens cell. Other implementations may include deformable lenses, where deformation of solid or liquid surfaces results in a change in the optical power. Such deformations can be effectuated using piezo-electric devices with associated electronics, controllers, and/or microprocessors.

In some embodiments, the high-resolution image can be calculated by interpolation algorithms in the image space. The input image is a set of two-dimensional point clouds, i.e., the set of (xᵢ, yᵢ, Iᵢ), where xᵢ and yᵢ are the coordinates, i is the index and Iᵢ is the measured intensity. For simplicity, our discussion here pertains to intensity values over a single band of wavelengths; however, the disclosed techniques can be generalized to intensity values over multiple bands of wavelengths and multiple polarization states. Two common types of interpolation algorithms are adaptive and non-adaptive algorithms. Examples of non-adaptive algorithms are nearest neighbor, bilinear, bicubic spline, sinc, Lanczos, box sampling, fractals and combinations thereof. Adaptive algorithms often use an edge detection algorithm to identify sharp edges in the image and apply different interpolations and parameters to minimize edge artifacts in the image. Examples of edge artifacts are aliasing, blurring and halo artifacts in the image where there is a sharp intensity change.

Alternatively, the high-resolution image can be calculated by interpolation algorithms in the Fourier space. In one implementation, the Fourier transform of the images is first calculated. The scaling theorem of Fourier transform is then applied to each image with a different magnification or scale. The scaling theorem is given by:

$$F \{ g ( cx , cy ) \} = \frac{G ( \frac{fx}{c} , \frac{fy}{c} )}{\vert c \vert} . \qquad ( 1 )$$

In Equation (1), F{·} is the Fourier transform, G=F{g} and f_{x,y} are spatial frequencies, and c is the scaling factor. The Fourier transforms of the image are combined or added in the frequency domain. The resulting data is converted back to image space by application of an inverse Fourier transform.

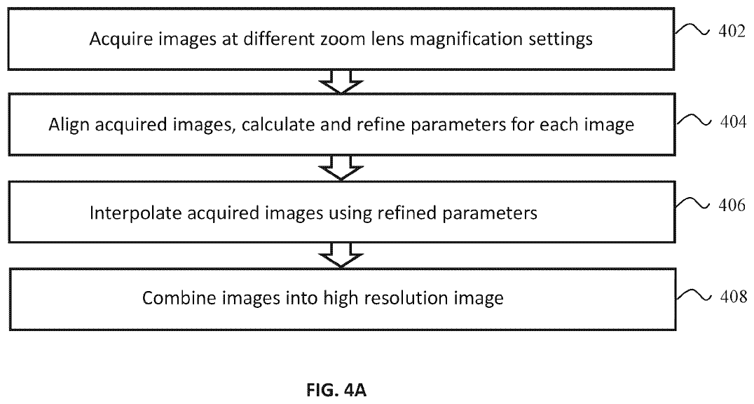

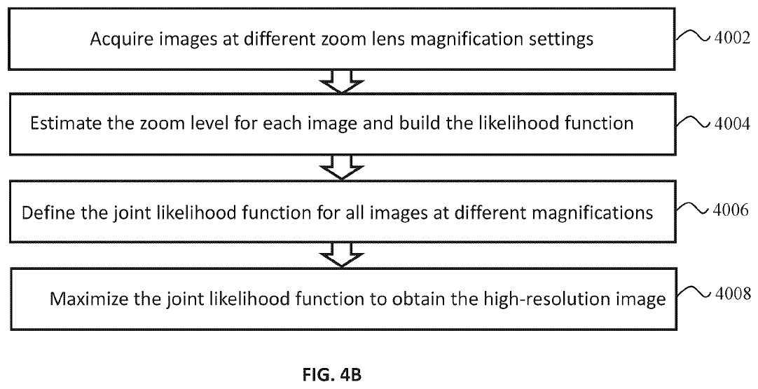

In some implementations, to account for the zoom lens distortion at different magnifications, the distortion can be initially calibrated and measured. The calibration data can be subsequently used to adjust the registration of the images taken at different zoom settings. Deep learning techniques that use, for example, convolutional neural networks, can be applied to the calculation of the high-resolution output image from the low-resolution input images. FIG. 4A illustrates an example method for producing a high-resolution image using multiple exposures in accordance with the disclosed technology. The method starts, at 402, by acquiring multiple images, each a particular magnification setting. Next, at 404, the images are optionally aligned and parameters for each image are calculated and/or refined. Example parameters include coefficients of the matrix for geometric transformation of the image. The acquired images are then interpolated at 406 using the refined parameters. Finally, the images are combined at 408 to produce a high-resolution image.

By the way of example, and not by limitation, the following description facilitates the understanding of the disclosed techniques. Let's describe the acquired image, gᵢ, at a given optical zoom level as:

gᵢ=DᵢHf+n.

In the above equation, f (vector) is a high-resolution discrete representation of the object (at multiples, e.g., 10×, of the optical cut-off frequency), H represents the discrete-to-discrete optical imaging operator that includes all optical transforms imparted by imaging optics (e.g., optical blur, distortion, vignetting etc.), Dᵢ, is a discrete-to-discrete operator representing the optical magnification/zoom and detector spatial integration and sampling on the focal plane array and n (vector) represents the measurement noise (e.g., detector read-out thermal noise, optical shot noise etc.). Given a collection of N such digital images, g={g₁, g₂, . . . , g_{N}}, acquired at as many distinct optical zoom levels in a predetermined range (say 0.5× to 1.5×), we can formulate the estimation of the original high-resolution \hat{f}_{ML} (i.e., beyond the detector spatial resolution limit) as the following optimization problem within the maximum likelihood (ML) framework:

$${\hat{f}}_{M L} = {ar max}_{f} p ( g \vert f ) .$$

In the above equations, p(g|f) is the likelihood function that can be defined given the measurement noise statistics. For example, if the image measurements are shot-noise limited, then the likelihood function follows the Poisson distribution form; whereas, if the image measurements are say read-out noise limited, then the likelihood function would have a multi-variate Gaussian distribution form. The maximum likelihood (ML) high-resolution image estimate can be obtained using well developed iterative algorithms, such as Maximum Likelihood Expectation Maximization (MLEM), Richardson-Lucy (RL), etc. Note that one can use Fourier transform to efficiently represent large matrix operators such as Dᵢ, and H, given their circulant-Toeplitz or block-circulant-Toeplitz structure.

FIG. 4B illustrates an example method for producing a high-resolution image using multiple exposures in accordance with the disclosed technology. The method starts at 4002 by acquiring multiple images, each a particular magnification setting. Next, at 4004, the zoom level for each image is estimated and then a maximum likelihood measure is built. A joint likelihood function is then defined at 4006 for all images at different magnifications. And finally, at 4008, the joint likelihood function is maximized to obtain the high-resolution image.

In some applications, multiple zoom lenses can be used to acquire images of the same object at different perspectives. Once multiple images are obtained, the disclosed methods can be applied to generate a high-resolution model of an object at different perspectives. As an example, in stereoscopy, two images of the same object can be displayed to different eyes to create an illusion of depth. As another example, in computer graphics, a 3D reconstruction can be estimated from multiple images of the same object.

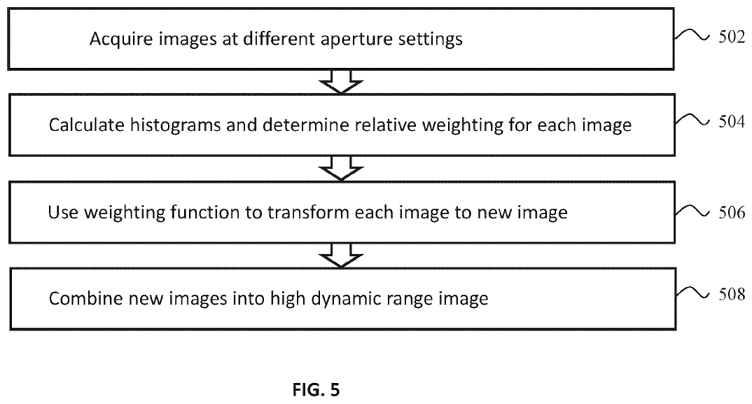

The disclosed embodiments can be implemented to additionally, or alternatively, increase the dynamic range of an image using multiple exposures. One common problem in imaging is the finite dynamic range of the sensor. An image taken at the optimal exposure condition can have saturated highlights, flat shadows, or both. The main cause of this problem is that the intensity range of the scene is often larger than the dynamic range of the imaging system. One common solution is to combine multiple images taken with different exposure times to generate a high dynamic range image (HDRI). The disclosed embodiments, on the other hand, can be implemented to obtain multiple images at different or same exposure times but at different aperture settings. With reference to the example configuration of FIG. 2, in one example embodiment, a first image is taken when the aperture 204 is set to open to allow maximal light input. A second image is taken when the aperture 204 is set to allow a smaller amount of light input. A third image is taken when the aperture 204 is to allow an even smaller amount of light input. A fourth image is taken when the aperture 204 is set to allow the minimal light input. The four images are combined to create a high dynamic range image. The exact aperture settings for the different exposures can be determined by the user or by an initial estimate of the dynamic range of the scene. Adjusting the aperture settings, while can be analogous to changing the exposure time, is different at least because results in reduced motion blur artifacts as compared to traditional schemes that are based on exposure time. The number of photons collected by each pixel in the sensor can be controlled by changing the lens aperture, the integration time or both. FIG. 5 illustrates an example set of operations to produce a high dynamic range image in accordance with an example embodiment. First, at 502, images at different aperture settings are acquired. Next, at 504, histograms are calculated and the relative weighting for each image is determined. Using the relative weighting values, each image is then transformed to a new image at 506. Finally, at 508, the new images are combined to form the high dynamic range image.

The following provides an example procedure for obtaining a high dynamic range image by combining multiple images. A photometric calibrated camera is used to acquire multiple 8-bit images at different aperture settings and at a fixed exposure time. The acquired images are registered using an image alignment algorithm, such as featured-based keypoint correspondences, similarity measures and/or by using deep neural networks. Regions of occlusion, underexposure and overexposure can be identified. The region of occlusion is expected to be small, if the camera and/or objects are not moving. A weighting function, such as a Gaussian function, is introduced for each image. The weighting function can have a value from zero to one, and is a function of irradiance. The parameters, such as the center and width, of each weighting function are determined by the aperture setting. One purpose of the weighting function is to discard saturated pixels. For pixels in a region of occlusion, a search is made for the closest pixel that is not in the region of occlusion. The value of the occluded pixel is set to that of the closest pixel. The weighting functions are applied to corresponding images and combined to create a final image which has a higher dynamic range.

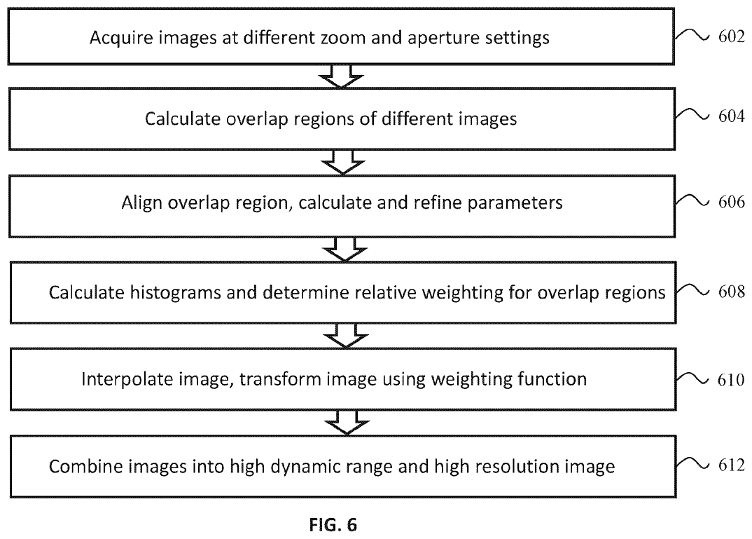

In some embodiments, a high-resolution and high dynamic range image can be generated by multiple exposures taken at different zoom and aperture settings. FIG. 6 illustrates an example set of operations to produce a high-resolution and high dynamic range image in accordance with an example embodiment. First, at 606, images at different zoom and aperture settings are acquired. For example, two images are obtained at one zoom and two aperture settings. Subsequently, another two images are obtained at another zoom and the same two aperture settings. Next, at 604, the overlap regions of different images are calculated; then, at 606, overlap regions are aligned and the parameters are calculated and aligned. Subsequently, at 608, histograms are calculated and the relative weighting for overlap regions are determined. At 610, images are interpolated and transformed using relative weighting values. Finally, at 612, the images are combined to form the high dynamic range and high-resolution images. In one example, images of fixed aperture and different zooms factors are first combined to a single image using, for example, one of the techniques discussed in connection with FIGS. 4A and 4B. The thus-combined images, each with a different aperture setting, are subsequently combined into a single image using, for example, the technique discussed in connection with FIG. 5. In another example, images of a fixed zoom factor and different aperture settings are first combined to a single image using, for example, the technique discussed in connection with FIG. 5. The thus-combined images, each with a different zoom factor, are subsequently combined into a single image using, for example, one of the techniques discussed in connection with FIGS. 4A and 4B.

In conventional imaging, a color filter, such as the Bayer filter, is placed on each pixel to provide color information. In polarization imaging, micro-polarizers, such as linear, elliptical and circular polarizers, are placed on each pixel to provide polarization information. The disclosed technology can be implemented in various embodiments by utilizing multi-spectral and/or polarization sensitive sensors to generate higher resolution and higher dynamic range images. One of advantages of the disclosed embodiments is that they can be implemented using existing hardware by modification of the firmware, provided that the existing hardware includes zoom control and/or an electronically controlled aperture.

The disclosed embodiments may be implemented as part of a stand-alone imaging system or can be implemented as component within a larger imaging system or device. For example, the disclosed embodiments can be implemented as part of a camera, a camcorder, a mobile phone, a laptop, a notebook device, a tablet, a drone, a vehicle, a surveillance system, an autonomous system or other devices. The optical system may include, or be coupled to, an electronic device that can communicate with and/or control some of the components of the optical components.

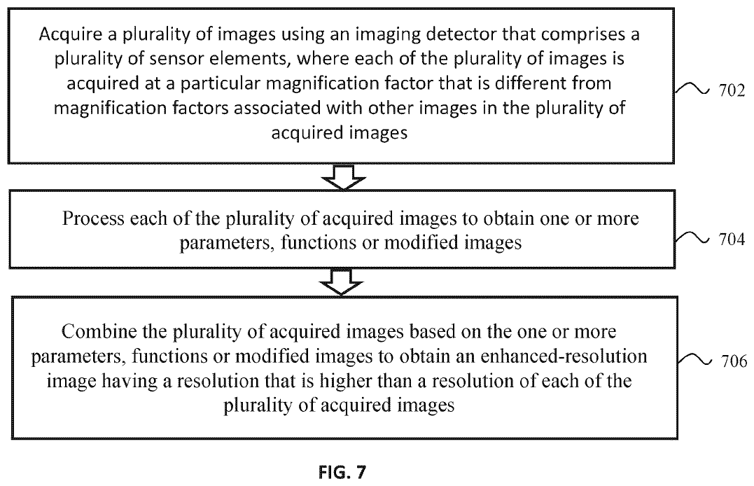

FIG. 7 illustrates a set of operations for obtaining an enhanced image with an imaging system in accordance with an example embodiment. At 702, a plurality of images is acquired using an imaging detector that comprises a plurality of sensor elements. Each of the plurality of images is acquired at a particular magnification factor that is different from magnification factors associated with other images in the plurality of acquired images. At 704, each of the plurality of acquired images is processed to obtain one or more parameters, functions or modified images. At 706, the plurality of acquired images are combined based on the one or more parameters, functions or modified images to obtain an enhanced-resolution image having a resolution that is higher than a resolution of each of the plurality of acquired images.

In one example embodiment, acquiring the plurality of images includes longitudinally shifting an optical element of the imaging system to obtain one or more of the plurality of images. In another example embodiment, the longitudinally shifting the optical element includes moving a lens of an optical zoom lens system. In still another example embodiment, acquiring the plurality of images includes modifying an optical power of an optical element of the imaging system to obtain one or more of the plurality of acquired images. In yet another example embodiment, the optical element includes a fluid and modifying the optical power comprises deforming the fluid to effectuate a change in the optical power of the optical element. In one example embodiment, modifying the optical power includes deforming the optical element without changing a location of the optical element within the imaging system.

According to another example embodiment, processing each of the plurality of acquired images comprises producing one or more interpolated or aligned images. In still another example embodiment, processing the plurality of acquired images comprises performing an adaptive interpolation that uses edge detection to detect sharp features in the plurality of acquired images. In one example embodiment, processing the plurality of acquired images comprises non-adaptive interpolation. In another example embodiment, processing each of the plurality of acquired images comprises estimating a zoom or magnification level for each of the acquired images and building a likelihood function for each of the plurality of acquired images. In yet another example embodiment, combining the plurality of acquired images comprises providing a joint likelihood function for the plurality of acquired images and maximizing the joint likelihood to obtain the enhanced-resolution image.

In one example embodiment, processing the plurality of acquired images comprises processing the plurality of acquired images in frequency domain. In another example embodiment, the plurality of acquired images consists of four images that are acquired at four different magnification factors. In still another example embodiment, the enhanced-resolution image is obtained without laterally shifting the imaging detector. In another example embodiment, the imaging system includes an aperture and the method for obtaining the enhanced-resolution image comprises acquiring a plurality of additional images by modifying an aperture setting, combining the plurality of acquired images, including the plurality of additional images, to obtain an image having both a resolution that is higher than a resolution of each of the plurality of acquired images and a dynamic range that is higher than a dynamic range of each of the plurality of additional images. In yet another example embodiment, modifying the aperture setting comprises modifying a size of the aperture to allow a different amount of light to reach the imaging detector for each of the plurality of additional images.

Another aspect of the disclosed embodiments relates to an imaging system for obtaining an enhanced image of an object that includes an optical zoom system comprising at least one lens, an imaging detector comprising a plurality of sensor elements and configured to receive light from the optical zoom system, and a processor coupled to a memory comprising instructions stored thereon. The processor is further coupled to the imaging detector and is configured to receive electrical signals from the imaging detector corresponding to images formed thereon. In the imaging system, the optical zoom system is operable to allow a plurality of images to be formed on the imaging detector, where each of the plurality of images is associated with a particular magnification factor that is different from magnification factors associated with other images in the plurality of images. The instructions upon execution by the processor of the imaging system configures the processor to receive data representing the plurality of images, to process the received data to produce one or more parameters, functions or modified images, and to combine the plurality of images based on the one or more parameters, functions or modified images to obtain an enhanced-resolution image having a resolution that is higher than a resolution of each of the plurality of images.

In one example embodiment, the optical zoom system is operable to longitudinally shift an optical element therein to allow the plurality of images to be formed on the imaging detector. In another example embodiment, the optical zoom system is operable to modify an optical power of an optical element therein to allow the plurality of images to be formed on the imaging detector. In still another example embodiment, the optical element includes a fluid that is configured to deform to effectuate a change in the optical power of the optical element. In yet another example embodiment, the plurality of images consists of four images formed at four different magnification factors.

According to another example embodiment, the enhanced-resolution image is obtained without laterally shifting the imaging detector. In another example embodiment, the instructions upon execution by the processor configure the processor to process one or more of the plurality of images to produce one or more interpolated or aligned images. In yet another example embodiment, the instructions upon execution by the processor configure the processor to perform one or more of: an adaptive interpolation that uses edge detection to detect sharp features in the plurality of images, a non-adaptive interpolation, or an interpolation in frequency domain. In still another example embodiment, the instructions upon execution by the processor configure the processor to process each of the plurality of images to produce an estimate of a zoom or magnification level and to produce a likelihood function for each of the plurality of acquired images.

In another example embodiment, the instructions upon execution by the processor configure the processor to combine the plurality of images by providing a joint likelihood function for the plurality of the acquired images and maximizing the joint likelihood to obtain the enhanced-resolution image. In one example embodiment, the imaging system includes an aperture and the instructions upon execution by the processor configure the processor to: change an aperture setting to allow a plurality of additional images to be formed on the imaging detector, and combine the plurality of images, including the plurality of additional images, to obtain an image having both a resolution that is higher than a resolution of each of the plurality of images and a dynamic range that is higher than a dynamic range of each of the plurality of additional images.

In one example embodiment, changing the aperture setting comprises changing a size of the aperture to allow a different amount of light to reach the imaging detector for each of the plurality of additional images. In another example embodiment, the imaging detector comprises one of a charged coupled device (CCD) sensor, a complementary metal oxide semiconductor (CMOS) sensor, a short wave infrared (SWIR) sensor, a mid wave infrared (MWIR) sensor, or a long wave infrared (LWIR) sensor.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

It is understood that the various disclosed embodiments may be implemented individually, or collectively, using devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. For example, the processor may be configured to receive electrical signals or information from the disclosed sensors (e.g., CMOS sensors), and to process the received information to produce images or other information of interest.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes

Only a few implementations and examples are described and other implementations, enhancements and variations can be made based on what is described and illustrated in this patent document.

1. A method for obtaining an enhanced image with an imaging system, the method comprising:
acquiring a plurality of images using an imaging detector that comprises a plurality of sensor elements, wherein each of the plurality of images is acquired at a particular magnification factor that is different from magnification factors associated with other images in the plurality of acquired images;
processing each of the plurality of acquired images to obtain one or more parameters, functions or modified images; and
combining the plurality of acquired images based on the one or more parameters, functions or modified images to obtain an enhanced-resolution image having a resolution that is higher than a resolution of each of the plurality of acquired images.

2. The method of claim 1, wherein acquiring the plurality of images includes longitudinally shifting an optical element of the imaging system to obtain one or more of the plurality of images.

3. The method of claim 2, wherein the longitudinally shifting the optical element includes moving a lens of an optical zoom lens system.

4. The method of claim 1, wherein acquiring the plurality of images includes modifying an optical power of an optical element of the imaging system to obtain one or more of the plurality of acquired images, wherein the optical element includes a fluid and modifying the optical power comprises deforming the fluid to effectuate a change in the optical power of the optical element.

5. (canceled)

6. The method of claim 4, wherein modifying the optical power includes deforming the optical element without changing a location of the optical element within the imaging system.

7. The method of claim 1, wherein processing each of the plurality of acquired images comprises producing one or more interpolated or aligned images, and wherein processing the plurality of acquired images comprises performing an adaptive interpolation that uses edge detection to detect sharp features in the plurality of acquired images.

8. (canceled)

9. The method of claim 1, wherein processing each of the plurality of acquired images comprises producing one or more interpolated or aligned images, and wherein processing the plurality of acquired images comprises non-adaptive interpolation.

10. The method of claim 1, wherein processing each of the plurality of acquired images comprises estimating a zoom or magnification level for each of the acquired images and building a likelihood function for each of the plurality of acquired images.

11. The method of claim 10, wherein combining the plurality of acquired images comprises providing a joint likelihood function for the plurality of acquired images and maximizing the joint likelihood to obtain the enhanced-resolution image.

12. The method of claim 1, wherein processing the plurality of acquired images comprises processing the plurality of acquired images in frequency domain.

13. (canceled)

14. The method of claim 1, wherein the enhanced-resolution image is obtained without laterally shifting the imaging detector.

15. The method of claim 1, wherein the imaging system includes an aperture and the method for obtaining the enhanced-resolution image comprises:
acquiring a plurality of additional images by modifying an aperture setting,
combining the plurality of acquired images, including the plurality of additional images, to obtain an image having both a resolution that is higher than a resolution of each of the plurality of acquired images and a dynamic range that is higher than a dynamic range of each of the plurality of additional images, wherein modifying the aperture setting comprises modifying a size of the aperture to allow a different amount of light to reach the imaging detector for each of the plurality of additional images.

16. (canceled)

17. An imaging system for obtaining an enhanced image of an object, comprising:
an optical zoom system comprising at least one lens;
an imaging detector comprising a plurality of sensor elements and configured to receive light from the optical zoom system; and
a processor coupled to a memory comprising instructions stored thereon, the processor further coupled to the imaging detector and configured to receive electrical signals from the imaging detector corresponding to images formed thereon, wherein:
the optical zoom system is operable to allow a plurality of images to be formed on the imaging detector, each of the plurality of images associated with a particular magnification factor that is different from magnification factors associated with other images in the plurality of images;
the instructions upon execution by the processor configuring the processor to:
receive data representing the plurality of images and to process the received data to produce one or more parameters, functions or modified images; and
combine the plurality of images based on the one or more parameters, functions or modified images to obtain an enhanced-resolution image having a resolution that is higher than a resolution of each of the plurality of images.

18. The imaging system of claim 17, wherein the optical zoom system is operable to longitudinally shift an optical element therein to allow the plurality of images to be formed on the imaging detector, without laterally shifting the imaging detector.

19. The imaging system of claim 17, wherein the optical zoom system is operable to modify an optical power of an optical element therein to allow the plurality of images to be formed on the imaging detector, wherein the optical element includes a fluid that is configured to deform to effectuate a change in the optical power of the optical element.

20. (canceled)

21. (canceled)

22. (canceled)

23. The imaging system of claim 17, wherein the instructions upon execution by the processor configure the processor to process one or more of the plurality of images to produce one or more interpolated or aligned images that includes one or more of:
an adaptive interpolation that uses edge detection to detect sharp features in the plurality of images,
a non-adaptive interpolation, or
an interpolation in frequency domain.

24. (canceled)

25. The imaging system of claim 17, wherein the instructions upon execution by the processor configure the processor to process each of the plurality of images to produce an estimate of a zoom or magnification level and to produce a likelihood function for each of the plurality of acquired images.

26. The imaging system of claim 18, wherein the instructions upon execution by the processor configure the processor to combine the plurality of images by providing a joint likelihood function for the plurality of the acquired images and maximizing the joint likelihood to obtain the enhanced-resolution image.

27. The imaging system of claim 17, wherein the imaging system includes an aperture and the instructions upon execution by the processor configure the processor to:
change an aperture setting to allow a plurality of additional images to be formed on the imaging detector, wherein changing the aperture setting comprises changing a size of the aperture to allow a different amount of light to reach the imaging detector for each of the plurality of additional images, and
combine the plurality of images, including the plurality of additional images, to obtain an image having both a resolution that is higher than a resolution of each of the plurality of images and a dynamic range that is higher than a dynamic range of each of the plurality of additional images.

28. (canceled)

29. The imaging system of claim 17, wherein the imaging detector comprises one of a charged coupled device (CCD) sensor, a complementary metal oxide semiconductor (CMOS) sensor, a short wave infrared (SWIR) sensor, a mid wave infrared (MWIR) sensor, or a long wave infrared (LWIR) sensor.
